(19) United States
(12) Patent Application Publication
(10) Pub. No.: US 2002/0086783 A1
(43) Pub. Date: Jul. 4, 2002

(54) Semiconductive roller and image forming apparatus

(75) Inventors: Kazuya Nakada, Kodama-gun (JP); Yoshinori Takahashi, Kodama-gun (JP)

Correspondence Address: Peter C. Schechter, Darby & Darby P.C., 805 Third Avenue, New York, NY, 10022, US

(73) Assignee: Shin-Etsu Polymer Co., Ltd

(21) Appl. No.: 09/841,926

(22) Filed: Apr. 25, 2001

(30) Foreign Application Priority Data
Nov. 1, 1999 (JP) HEI 11-311219

(51) Int. Cl. B25F 5/02; F16C 13/00

(52) U.S. Cl. 492/59; 492/56

(57) ABSTRACT

A semiconductive roller comprises a semiconductive elastic layer made of silicone rubber covering the circumference of a conductive shaft body, and a resin layer containing a hard film material is formed on the outer circumference of the elastic layer via a coupling agent layer.

### BACKGROUND OF THE INVENTION

1. Field of the Invention

The present invention relates to a semiconductive roller preferably used as charging roller, developing roller, transfer roller or cleaning roller used around a photoreceptor drum of an image forming apparatus composed of a copier, LBP (laser beam printer), facsimile and others for forming images by electrophotographic system, and an image forming apparatus.

2. Description of the Prior Art

Office automation apparatuses by electrophotographic system include copier, printer, and facsimile, and in the developing process of such apparatuses, frictionally electrified toner is held on a carrier in a thin layer, and an electrostatic latent image on a photosensitive drum is visualized and developed. As the carrier, a metal hard roller or an elastic roller of semiconductive elastic material is generally used, but in the latter case, the material is required to have various properties including electrical conductivity, environmental resistance, low hardness, and frictional electrifying characteristic. Accordingly, for manufacture of elastic roller, semiconductive materials are used, for example, elastomer such as urethane rubber, NBR, or silicone rubber filled with electron conductor or ion conductor.

However, to lower the hardness of urethane rubber or NBR, it is necessary to add liquid material such as process oil and softening agent, and it leads to a problem of bleeding of low molecule substance of liquid material onto the surface of the elastic roller. By contrast, the semiconductive roller of silicone rubber capable of lowering the hardness without adding liquid material has a stable environmental resistance and a sharp charge distribution in negative charge toner, and it is very effective for improving the photographic fog.

Although the semiconductive roller made of silicone rubber is effective for improving the fog, in the manufacturing process of polysiloxane which is the base of the rubber, small amount of siloxane of low molecular weight is secondarily generated together with siloxane of high molecular weight, which gradually exude onto the roller surface from the matrix of the crosslinked silicone rubber, thereby lowering the adhesion and flowability of toner, resultingly high quality printing may not be maintained. Also, when manufacturing the semiconductive roller by using silicone rubber, while the electric characteristic is excellent, the mechanical strength is insufficient as compared to the synthetic rubber; therefore, when the roller is set in an apparatus for operation, there is a problem in overall durability, even though an initial performance is excellent. In particular, in the case of contact development system, since the developing roller and charging roller are installed in contact with the photoreceptor drum, rotational failure, flaw or abrasion may occur due to friction with the photoreceptor drum, and the friction coefficient p of the roller surface increases.

Furthermore, as a result of the foregoing, when flaw or wear mark is formed on the roller surface, the toner sticks to these recess, resulting in overlaid toner layer, which makes lack in toner charge amount in the area, thus causing a fog to lower the print quality. These problems were thought to be unavoidable when the roller was composed of silicone rubber alone, but recently, in order to solve these problems, it has been attempted to coat the roller surface with a hard resin material excellent in wear resistance and low in the coefficient p. However, some types of the resin materials exhibit problems in adhesiveness to the silicone rubber or flexing resistance.

### SUMMARY OF THE INVENTION

The invention is devised in the light of the above problems, and it is hence an object thereof to present a semiconductive roller and an image forming apparatus capable of realizing advanced wear resistance and low μ of the roller surface, and improving the charge characteristic, without sacrificing the flexibility and environmental resistance of silicone rubber.

The present invention, to achieve the object, has the following aspects.

In accordance with the first aspect of the present invention, a semiconductive roller comprises: a semiconductive elastic layer made of silicone rubber formed around a conductive shaft body, wherein a resin layer including a hard film material is formed on the outer circumference of the elastic layer via a coupling agent layer.

In accordance with the second aspect of the present invention, an image forming apparatus comprises: a semiconductive roller comprising a semiconductive elastic layer made of silicone rubber formed around a conductive shaft body, wherein the semiconductive roller made of a resin layer including a hard film material formed on the outer circumference of the elastic layer via a coupling agent layer, characterized in that the semiconductive roller is used at least as charging roller, developing roller, transfer roller, or cleaning roller.

### DESCRIPTION OF THE PREFERRED EMBODIMENTS

A semiconductive roller of the present invention is described in detail below.

First, as the hard film material, it is preferred to use an amino resin. As components of the resin layer, polyol, diol, or their isocyanate reaction product (urethane prepolymer) may be used. Usable components of resin layer also include silicone urethane prepolymer and amino denatured silicone urethane prepolymer. A copolymer of ester acrylate and acrylic acid may be also used as the component of resin layer.

That is, as mentioned above, as the hard film material of semiconductive roller of the present invention, amino resins are used (including urea resin, melamine resin, benzoguanamine resin, and acetoguanamine resin). The amino resin is prepared by addition condensation of amino compound and formaldehyde, and etherification of part of produced methylol group by alcohol. In particular, when the amino resin is butyl etherified by heating together with butanol in weak acidity, the compatibility with various resins is enhanced, and a stable film is formed by three-dimensional crosslinking at a relatively low temperature. An amino resin is, when used alone, forms a hard and brittle film, and is preferably used together with other crosslinking prepolymer, or other resin as required. Among amino resins, the best material is the melamine resin, and in this case, as the starting material of melamine resin, urea resin may be used. As the urea resin, trimethylol melamine, hexatrimethyl melamine and others may be preferably used. However, the hard film material of the present invention is not limited to these resins.

The material reacting or crosslinking with the hard film material includes polyol, diol, or their isocyanate reaction product (urethane prepolymer), silicone urethane prepolymer, amino denatured silicone urethane prepolymer, and copolymer of ester acrylate and acrylic acid, among others. By adding these resin components, a film having both high hardness and flexibility is formed. Examples of polyol include polyester polyol, polyether polyol, acrylic polyol, and epoxy polyol, and examples of diol include polyester diol, polyether diol, and polycarbonate diol.

The isocyanate used in the isocyanate reaction product includes aromatic isocyanates, such as trilene diisocyanate, diphenyl methane diisocyanate, polymethylene polyphenyl isocyanate, tolidine diisocyanate, naphthalene diisocyanate, and the like, and aliphatic isocyanates such as hexamethylene diisocyanate, isophorone diisocyanate, xylene diisocyanate, hydrogenated xylene diisocyanate, dimeric acid diisocyanate, tetramethyl hexamethylene diisocyanate, lysine isocyanate methyl ester, and the like.

These flexibility components such as polyol, diol and urethane prepolymer are mixed with the amino resin in an organic solvent, and heated, and are cured to form a film by crosslinking reaction between methylol group in the amino resin and hydroxyl group, de-butanol reaction of butoxy group in the amino acid, or crosslinking reaction with hydroxyl group by ether exchange, and in mixing it is important to select a proper combination so as not to be decomposed easily by comparing the solubility parameter, and other compatibility index data. The mixing ratio of two components is appropriately determined depending on the conditions of the required hardness and flexibility, and is not particularly limited, but considering the hardness, flexibility, adhesion with base material, and others, a general range of ratio of amino resin/ crosslinking component=50/50 to 10/90 (w/w). To form a more flexible film, preferably, the range is 40/50 to 20/80 (w/w). In the resin layer component of the invention, for the purpose of fine adjustment of film hardness and surface condition, silica or silicone resin powder, talc, or other inorganic or organic filler component may be added, which does not impair the purport of the present invention.

The conductive shaft body is made of core such as iron, stainless steel, aluminum alloy, brass, or other conductive metal, or other shaft made of thermoplastic resin or thermosetting resin, and it is blended with conductivity donor to form a conductive resin. An elastic layer made of silicone rubber composition is vulcanized and formed into a roller together with the shaft body by extrusion molding, press forming, injection molding, or mold forming, and further vulcanized secondarily in a Geer oven, and the surface is ground by a cylindrical grinder. The coupling agent layer is treated by an ordinary method, and the coupling agent is not particularly limited, and may include silane coupling agent and titanate coupling agent. These coupling agents may be diluted in the solvent at a ratio designated by the manufacturer, and applied.

The means for forming a resin layer on the elastic layer surface is not particularly limited, but an applying method by forming a solution is normal. The applying means may include roll coater, gravure coater, spray coater, and other general coating machines, or dipping method of immersing directly in the resin solution may be also possible. The resin layer forming means is not limited to them alone as far as a resin component can be on the surface of the elastic layer, and, for example, a silicone resin may be preliminarily formed in a cylindrical shape by injection molding or press forming, and inserted by pressure into the elastic layer.

Examples of the present invention and comparative examples of the semiconductive roller and their test results are explained below.

### EXAMPLE 1

The conductive shaft body is an electroless nickel plated shaft of SUM 22, 10 mm in diameter and 400 mm in length, and a mixture of silicone primer No. 23 and No. 4 (tradename of Shin-Etsu Chemical Co, Ltd.) by 1:1 was applied thereon, and baked in a Geer oven at 150° C. for 10 minutes.

The semiconductive silicone rubber composition was prepared by using 100 parts by weight of organic peroxide reaction type silicone crude rubber KE-78VBS (tradename of Shin-Etsu Chemical Co, Ltd.), 10 parts by weight of carbon black Thermal Black (tradename of Asahi Carbon Co, Ltd.), and 25 parts by weight of fogging silica filler Aerosil 200 (tradename of Japan Aerosil Co, Ltd.), kneading in a pressurized kneader, and adding 2.0 parts by weight of organic peroxide type vulcanizing agent C-8 (tradename of Shin-Etsu Chemical Co, Ltd.). It was vulcanized, adhered and formed together with the shaft body in a compressive molding die of cylindrical cavity of 20 mm in inside diameter for 10 minutes at 175° C. After secondary vulcanization for 7 hours at 200° C. in a Geer oven, it was ground by a cylindrical grinder, and a roller shaped piece of 18 mm in diameter and 320 mm in the rubber section length, with a solid and semiconductive elastic layer formed on the outer circumference of the shaft body was obtained.

As the resin layer, a mixed paint of butyl etherified melamine resin/polyester polyol=30/70 (w/w) was prepared, and applied on the surface of the roller shaped piece coated with primer C (tradename of Shin-Etsu Chemical Co, Ltd.) in a film thickness of 15 μm by means of a spray coater, and dried and cured in a Geer oven for 30 minutes at 140° C., and a semiconductive roller of the present invention was completed, and evaluated in the following test.

Test

Test items

(1) Initial and after-aged Macbeth density

By continuous test printing of 5000 sheets by electrophotographic printer (using 5% duty pattern for continuous printing), after the fifth sheet and 5000th sheet, an evaluation pattern (a set of series of printing patterns comprising black solid, halftone, blank print) was printed, and the Macbeth density of the black cells of each pattern image was measured by a Macbeth densitometer, and it was approved when the measurement was 1.3 or more.

(2) Initial and after-aged fog

By continuous test printing of 5000 sheets by electrophotographic printer (using 5% duty pattern for continuous printing), after the fifth sheet and 5000th sheet, an evaluation pattern (a set of series of printing patterns comprising black solid, halftone, blank print) was printed, and the fog score in a range of 0.5×1 mm of blank portion beneath black cells of each pattern image was magnified and measured by a CCD camera (200 times), and it was approved when the score was 15 or less.

(3) Initial and after-aged black solid follow-up property

By continuous test printing of 5000 sheets by electrophotographic printer (using 5% duty pattern for continuous printing), after the fifth sheet and 5000th sheet, an evaluation pattern (a set of series of printing patterns comprising black solid, halftone, blank print) was printed, and the Macbeth density of each black solid image was measured in every roller period (6 points in each image), and the density change rate of the first point and sixth point was calculated, and it was approved when the calculated value was 0.98 or more.

(4) After-aged developing roller surface observation

After continuous test printing of 5000 sheets, the developing roller was taken out of the developing apparatus, and presence or absence of cracks of resin layer was visually examined, and it was approved when no crack was detected.

(5) Flexing resistance test (conforming to JIS K 5400, 6.16)

On one side of a tin plate (about 150×50×0.3 mm), a resin layer of film thickness of 15 μm was uniformly formed, and dried and cured in predetermined conditions to prepare a test piece, and two pieces of flex tester main body were opened to form a flat plane and the test piece was inserted between the flex tester main body and a core (10 mm in diameter), with the coated side facing outside to the core, and immediately folded by about 180 degrees around the core. Taking out test pieces, and removing about 10 mm each from the both ends of the flex part, the remaining area was visually inspected for crack or peeling of paint, and it was approved when crack or peeling was not observed in the paint of the coat film in two or more of three test pieces.

### EXAMPLE 2

The resin layer component of Example 1, polyester polyol, was prepolymerized by isocyanate into urethane prepolymer, and butyl etherified melamine resin and urethane prepolymer were mixed at a ratio of 25/75 (w/w). A roller piece was formed in the same manner as in Example 1 except for this mixture, and the formed piece was tested in the same manner as in Example 1, and used as resin layer.

### EXAMPLE 3

The resin layer in Example 1 was replaced by a mixture of butyl etherified melamine resin/silicone urethane polymer=25/75 (w/w). A roller piece was formed in the same manner as in Example 1 except for this resin layer, and the formed piece was tested same as in Example 1.

### EXAMPLE 4

The resin layer in Example 1 was replaced by a mixture of butyl etherified melamine resin/amino denatured silicone urethane polymer=25/75 (w/w). A roller piece was formed in the same manner as in Example 1 except for this resin layer, and the formed piece was tested same as in embodiment 1.

### EXAMPLE 5

The resin layer in Example 1 was replaced by a mixture of butyl etherified melamine resin/copolymer of methyl methacrylate and methacrylic acid=30/70 (w/w). A roller piece was formed in the same manner as in Example 1 except for this resin layer, and the formed piece was tested same as in Example 1.

### Comparative example 1

As the resin layer, a mixture of melamine resin/oil-free alkyd resin=30/70 (w/w) was used. A roller piece was formed in the same manner as in Example 1 except for this resin layer, and the formed piece was tested same as in Example 1.

As a result, cracks were formed in the surface of the aged roller, and it was rejected. The flexing resistance test was also rejected.

### Comparative example 2

As the resin layer, silicone paint KP-801M was used. A roller piece was formed in the same manner as in Example 1 except for this resin layer, and the formed piece was tested same as in Example 1.

As a result, it was rejected in the Macbeth density of black cells, fog score, and black solid follow-up property.

### Comparative Example 3

As the resin layer, styrene acryl CPR100 (Mitsui Chemical Co, Ltd.) was used. A roller piece was formed in the same manner as in Example 1 except for this resin layer, and the formed piece was tested same as in Example 1.

As a result, it was rejected in the fog score and black solid follow-up property. It was also rejected in the flexing resistance test.

Test results of Examples 1, 2, 3, 4, 5, and comparative examples 1, 2, 3 are summarized in Table 1.

TABLE 1

| | Flexing | | | | | | Black solid | |
|---|---|---|---|---|---|---|---|---|
| | resistance | Crack after | Macbeth density | | | | follow-up | |
| | test | aging | of black cells | | Fog score | | property | |
| | ◯Approved | ◯None | 5^{th} | 5000th | 5th | 5000th | 5th | 5000th |
| | X Rejected | X Found | sheet | sheet | sheet | sheet | sheet | sheet |
| Example 1 | ◯ | ◯ | 1.42 | 1.46 | 6 | 8 | 0.99 | 0.99 |
| Example 2 | ◯ | ◯ | 1.41 | 1.44 | 9 | 14 | 0.98 | 0.98 |
| Example 3 | ◯ | ◯ | 1.31 | 1.34 | 8 | 10 | 0.98 | 0.98 |
| Example 4 | ◯ | ◯ | 1.38 | 1.42 | 8 | 9 | 0.98 | 0.98 |
| Example 5 | ◯ | ◯ | 1.35 | 1.40 | 10 | 12 | 0.98 | 0.98 |
| Comparative | X | X | 1.40 | 1.35 | 9 | 12 | 0.98 | 0.95 |
| Example 1 | | | | | | | | |
| Comparative | ◯ | ◯ | 1.27 | 1.25 | 19 | 26 | 0.95 | 0.95 |
| Example 2 | | | | | | | | |
| Comparative | X | ◯ | 1.42 | 1.45 | 18 | 24 | 0.96 | 0.92 |
| Example 3 | | | | | | | | |

Thus, according to the present invention, since the resin layer containing a hard film material is formed on the outer circumference of the elastic layer via a coupling agent layer, enhanced wear resistance and low p of roller surface are realized without sacrificing the flexibility of silicone rubber. At the same time, the electrifying characteristic can be improved.

What is claimed is:

1. A semiconductive roller comprising: a semiconductive elastic layer made of silicone rubber formed around a conductive shaft body, wherein a resin layer including a hard film material is formed on the outer circumference of said elastic layer via a coupling agent layer.

2. An image forming apparatus comprising a semiconductive roller comprising a semiconductive elastic layer made of silicone rubber formed around a conductive shaft body,
wherein the semiconductive roller made of a resin layer including a hard film material formed on the outer circumference of the elastic layer via a coupling agent layer, characterized in that the semiconductive roller is used at least as charging roller, developing roller, transfer roller, or cleaning roller.
